(19) United States
(12) Patent Application Publication
(10) Pub. No.: US 2026/0002744 A1
(43) Pub. Date: Jan. 1, 2026

(54) AUTOMATED SHELL AND TUBE HEAT EXCHANGER CLEANER

(71) Applicant: Intel Corporation, Santa Clara, CA (US)

(72) Inventors: Pranav SANGHADIA, Chandler, AZ (US); Jared BOTTLINGER, Chandler, AZ (US); Jonathon Whitney PARKER, Prescott, AZ (US); Ryan RISLUND, Chandler, AZ (US); Srikanth BANAGERE MANJUNATHA, Tempe, AZ (US); Joseph ROBISON, Gilbert, AZ (US); Nader SHAKERIN, Mesa, AZ (US); Jesus Angel VILLAFANA, Glendale, AZ (US); Vihari GANDRAKOTA, Tempe, AZ (US); Guston LIGHTHOUSE, Chandler, AZ (US); Huy Duc NGUYEN, Ho Chi Minh City (VN)

(21) Appl. No.: 18/759,667

(22) Filed: Jun. 28, 2024

(51) Int. Cl. F28G 15/00; B08B 9/043; F28G 15/04; F28G 15/08

(52) U.S. Cl. CPC F28G 15/003; B08B 9/0436; F28G 15/04; F28G 15/08; B08B 2209/04

(57) ABSTRACT

Systems for cleaning bundles of fluid conduits include mechanisms for detecting and mapping fluid conduit locations as well as moving a cleaning device to the detected and mapped fluid conduit locations. Systems can clean the fluid conduits in a fluid conduit bundle, such as the fluid conduits of a heat exchanger.

### FIELD

Descriptions are generally related to fluid-based cooling equipment, and more particular descriptions are related to cleaning conduits in a chiller.

### BACKGROUND

Chillers are used for cooling buildings, processes, and equipment. Chillers can include conduits that cool fluid arriving from locations in need of thermal management using, for example, fluid from a second source, such as a cooling tower. The fluid used can be water. Water-based chillers typically are cleaned every one to five years depending on the quality of the water at the site. Each cleaning on average requires two days of work and support from up to four technicians. The cleaning process additionally presents a risk of ergonomic or other injury for the technicians. The process of cleaning these tubes can be referred to as punching and involves passing a large cleaning instrument through each conduit to remove deposits that build up on the interior walls over time from a cooling fluid such as water.

### BRIEF DESCRIPTION OF THE DRAWINGS

The figures are provided to aid in understanding the disclosure. The figures can include diagrams and illustrations of examples of structures, assemblies, data, methods, and systems. For ease of explanation and understanding, these structures, assemblies, data, methods, and systems, the figures are not an exhaustively detailed description. The figures therefore should not be understood to depict the entire metes and bounds of structures, assemblies, data, methods, and systems possible without departing from the scope of the disclosure. Additionally, features are not necessarily illustrated relatively to scale due in part to the small sizes of some features and the desire for clarity of explanation in the figures.

FIGS. 1A-1B illustrate parts of a liquid-based cooling system that can be used to cool a building or other structure.

FIGS. 2A-2B show a heat exchanger and a system capable of cleaning fluid conduits.

FIG. 3 provides an example controller configuration for and a system capable of cleaning fluid conduits.

FIG. 4 provides a software stack for a system capable of cleaning fluid conduits.

FIG. 5 describes a process for detecting a location of a fluid conduit.

FIG. 6 diagrams a mapping algorithm a system capable of cleaning fluid conduits.

FIG. 7 shows a cleaning algorithm for a system capable of cleaning fluid conduits.

FIG. 8 provides an example of a computing system.

Descriptions of certain details and implementations follow, including non-limiting descriptions of the figures, which depict some examples and implementations.

### DETAILED DESCRIPTION

References to one or more examples are to be understood as describing a particular feature, structure, or characteristic included in at least one implementation. The phrases “one example” or “an example” are not necessarily all referring to the same example or embodiment. Any aspect described herein can potentially be combined with any other aspect or similar aspect described herein, regardless of whether the aspects are described with respect to the same figure or element.

The words “connected” and/or “coupled” can indicate that two or more elements are in direct physical or electrical contact with each other. The term “coupled,” however, can also mean that two or more elements are not in direct contact with each other and are instead separated by one or more elements but they may still co-operate or interact with each other, for example, physically, magnetically, optically, or electrically.

The words “first,” “second,” and the like, do not indicate order, quantity, or importance, but rather are used to distinguish one element from another. The words “a” and “an” herein do not indicate a limitation of quantity, but rather denote the presence of at least one of the referenced items. The terms “follow” or “after” can indicate immediately following or following some other event or events. Other sequences of operations can also be performed according to alternative embodiments. Furthermore, additional operations may be added or removed depending on the application.

Disjunctive language such as the phrase “at least one of X, Y, or Z,” is used in general to indicate that an element or feature, may be either X, Y, or Z, or any combination thereof (e.g., X, Y, and/or Z). Thus, this disjunctive language should be understood not to imply that certain embodiments require at least one of X, at least one of Y, or at least one of Z to each be present.

Flow diagrams as illustrated herein provide examples of sequences of various process actions. The flow diagrams can indicate operations to be executed by a software or firmware routine, as well as by physical operations. Physical operations can be performed by equipment, devices, instruments, motors, and/or machines for example, as described herein. Although shown in a particular sequence or order, unless otherwise specified, the order of the actions can be modified. Thus, the illustrated diagrams should be understood as examples. The processes can be performed in a different order, and some actions can be performed in parallel. Additionally, one or more actions can be omitted and not all implementations may necessarily perform all actions.

Various components described can be a means for performing the operations or functions described. Components described can include software, hardware, or a combination of these. Some components can be implemented as software modules, hardware modules, special-purpose hardware (for example, application specific hardware, application specific integrated circuits (ASICs), and digital signal processors (DSPs)), embedded controllers, and/or hardwired circuitry.

To the extent various computer operations or functions are described herein, they can be described or defined as software code, instructions, configuration, and/or data. The software content can be provided via an article of manufacture with the content stored thereon, or via a method of operating a communication interface to send data via the communication interface. A machine-readable storage medium can cause a machine to perform the functions or operations described. A machine-readable storage medium includes any mechanism that stores information in a tangible form accessible by a machine (e.g., computing device), such as recordable/non-recordable media (e.g., read only memory (ROM), random access memory (RAM), magnetic disk storage media, optical storage media, flash memory devices). Instructions can be stored on the machine-readable storage medium in a non-transitory form. A communication interface includes any mechanism that interfaces to, for example, a hardwired, wireless, or optical medium to communicate to another device, such as, for example, a memory bus interface, a processor bus interface, an Internet connection, a disk controller.

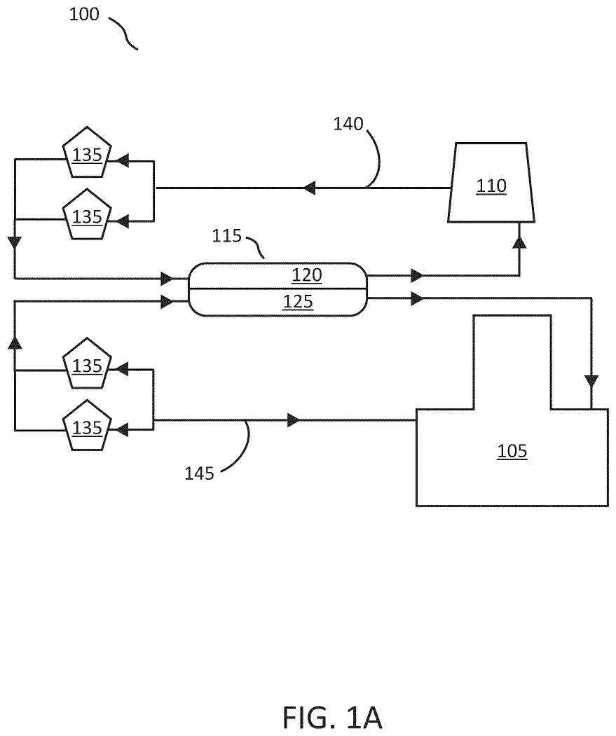

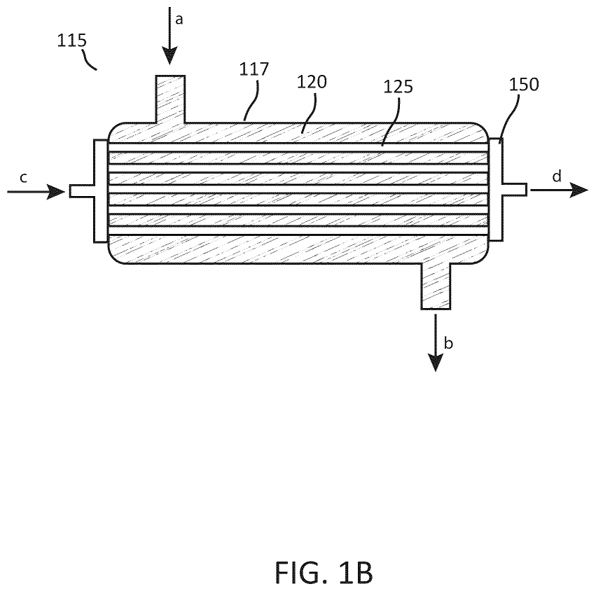

FIG. 1A illustrates an example of a cooling system 100 for a building or other structure. FIG. 1B provides a cut-through view of the inside of an example enclosed heat exchanger 115. In FIG. 1A, a building 105 is cooled by a cooling unit 110 through an enclosed heat exchanger 115. Enclosed heat exchanger 115 comprises fluid flow sections 120 and 125 that separate fluid from a cooling unit 110 from fluid from a building 105. The cooling unit 110 can be, for example, a cooling tower, such as a crossflow, a counterflow, an induced draft, or a forced draft cooling tower, depending on the type of fluid used in the cooling unit 110 system. Cooling towers typically use water as the fluid and can operate by allowing water and air to contact each other so that a small amount of water is evaporated reducing the temperature of the remainder of the water in the cooling tower. The cooling system 100 also includes fluid pumps 135. Although four fluid pumps 135 are shown, other numbers are possible, such as fewer than 4 or more than 4. Fluid pumps 135 pump fluid around the cooling system 100 using fluid conduits 140 and 145. Fluid conduits 140 are associated with cooling unit 110 and enclosed heat exchanger 115 fluid flow section 120. Fluid conduits 145 are associated with building 105 and enclosed heat exchanger 115 fluid flow section 125. Arrows indicate the direction of fluid flow in fluid conduits 140 and 145.

FIG. 1B illustrates additional features of an example of an enclosed heat exchanger 115 of FIG. 1A cooling system 100. Enclosed heat exchanger 115 includes a housing 117 and an enclosed fluid flow region 120 that surrounds fluid conduits 125. In the example of FIG. 1A, the enclosed fluid flow region 120 can enclose flowing cooled fluid from the cooling unit 110 into the enclosed fluid flow region 120 and the fluid conduits 125 can enclose flowing warmer fluid from the building 105 to allow heat to be exchanged between a warmer fluid and a cooler fluid. Although only five fluid conduits 125 are illustrated, many more are possible. Fluid conduits 125 can be copper tubes, for example. Manifolds 150 can allow fluid to enter and leave fluid conduits 125. Arrows “a,” “b,” “c,” and “d” indicate the direction of fluid flow.

Continuous flow of a fluid, such as water, through fluid conduits can create a layer of minerals on the walls of the conduits. For a typical fluid conduit that is a tube, a layer of minerals as small as 0.6 mm thick can reduce the efficiency of a typical heat exchanger by 20%. It can be difficult to predict or know the state of a heat exchanger over time since the composition of water sources used in the heat exchanger can vary.

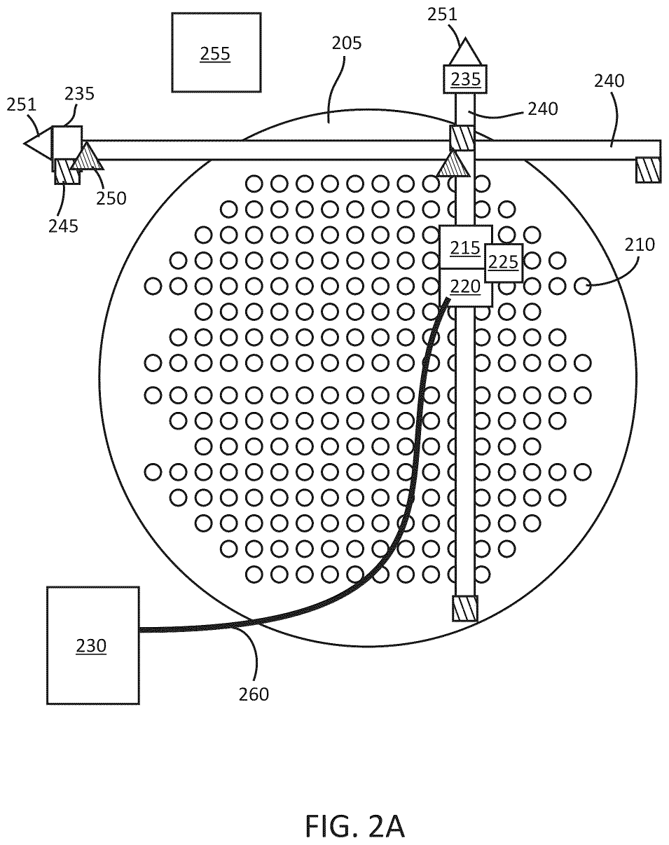

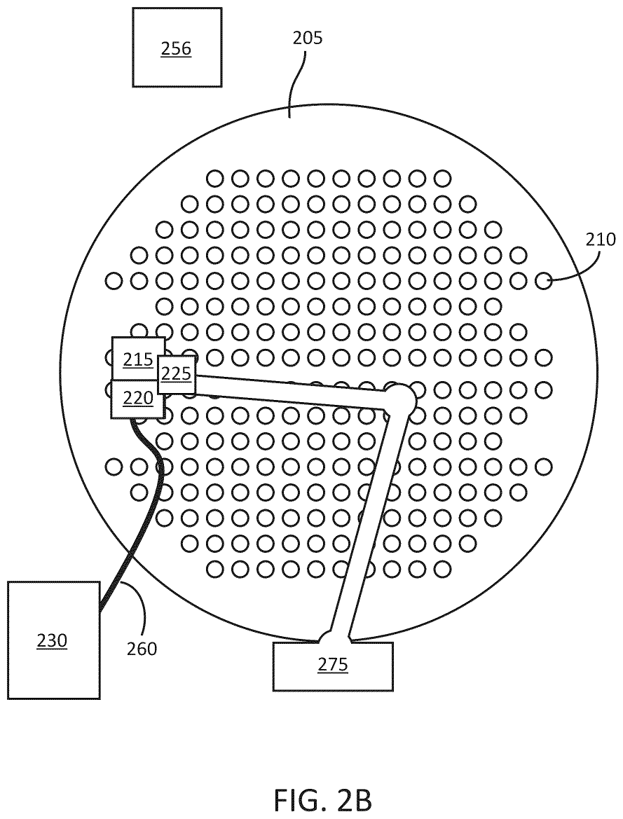

FIGS. 2A and 2B show the fluid conduits of a heat exchanger and a system capable of cleaning fluid conduits. The heat exchanger comprises a housing face plate 205 and fluid conduits 210. The fluid conduits 210 can span the length of a heat exchanger, such as, for example, in the manner that the fluid conduits 120 of enclosed heat exchanger 115 of FIG. 1B do. The fluid conduits 120 can be comprised of a metal, such as for example, copper or aluminum. Other materials are possible and the heat exchangers discussed herein are provided for explanation purposes and are not meant to limit the ways that the assemblies capable of cleaning fluid conduits described here in can be used.

In FIGS. 2A and 2B, systems capable of cleaning fluid conduits comprise a camera 215, a conduit mechanical cleaning device 220, and optical sensor 225. These systems can also include a mechanism (not shown) for attachment to the heat exchanger comprises a housing face plate 205. The camera 215 can supply images to a computer vision model that allows fluid conduits to be recognized. The mechanical cleaning device 220 can be a device that is capable of cleaning mineral deposits from a tube and can be one that capable of extending into the length of a tube. For example, the mechanical cleaning device 220 can comprise a brush, a brush that is capable of spinning, vibrating, or performing other movement, or other cleaning device such as a scrub pad, or a spinning, vibrating, or translating scrub pad. The conduit mechanical cleaning device 220 can also comprise a flexible housing 260 that includes a conduit for a fluid and a nozzle or other outlet that allows a liquid to flow out. The liquid flow can cause debris to be rinsed from a tube as the mechanical cleaning device 220 traverses the length of a fluid conduit 210. Flexible housing 260 can also include power for a motor or other mechanism to cause the mechanical cleaning device 220 to spin. The operation of the mechanical cleaning device 220 can be operated through cleaning control unit 230 that can actuate the translation of mechanical cleaning device 220 through a tube, control the spinning of brush or scrub pad. The cleaning control unit 230, can be, for example, a commercially available device, such as a facility maintenance tube cleaning device manufactured by Goodway Technologies (Stamford, CT).

In FIG. 2A, motors 235 operate on threaded rods 240 that are mounted on bars or rails, to cause the translation of the camera 215, a conduit mechanical cleaning device 220, and optical sensor 225 over a surface of a device comprising tubes, such as, for example, the face plate of a heat exchanger (the housing face plate 205). Motors 235, can be, for example, stepper motors. Translation limiters 245 can be, for example, limit switches, and they can be part of the control mechanism that limits the translation of the camera 215, the conduit mechanical cleaning device 220, and optical sensor 225, to the desired regions of a face plate of a heat exchanger. The system capable of cleaning fluid conduits can also include optional time of flight (ToF) sensors 250 that can measure distances and/or quadrature encoders 251. Time of flight sensors 250 and/or quadrature encoders 251 can provide data that the fluid conduit cleaning system uses to determine the location of the conduit mechanical cleaning device 220 relative to the heat exchanger comprises a housing face plate 205. Optical sensor 225 can provide data that the fluid conduit cleaning system uses to determine whether or not the conduit mechanical cleaning device 220 has been fully retracted from a fluid conduit after being inserted into the fluid conduit. The system capable of cleaning fluid conduits of FIG. 2A also includes a controller 255, which can include a microcontroller that can be coupled to a computing device. The controller 255 can provide power to, drivers for, and/or communication interfaces for motors 235, camera 215, a conduit mechanical cleaning device 220, optical sensor 225, quadrature encoders 251, and/or time of flight sensors 250 through wired (not shown) or wireless connections.

FIG. 2B a robotic arm assembly 275 to cause the translation of the camera 215, a conduit mechanical cleaning device 220, and optical sensor 225 over a surface of a device comprising tubes, such as, for example, the face plate of a heat exchanger (the housing face plate 205. The robotic arm assembly 275 can comprise one or more motors, such as stepper motors, and an arm comprising pivots. The system capable of cleaning fluid conduits of FIG. 2B also includes a controller 256, which can include a microcontroller and a computing device. The controller 256 can provide power to, drivers for, and/or communication interfaces for robotic arm assembly 275, camera 215, a conduit mechanical cleaning device 220, and optical sensor 225, quadrature encoders 251, and/or time of flight sensors 250 through wired (not shown) or wireless connections.

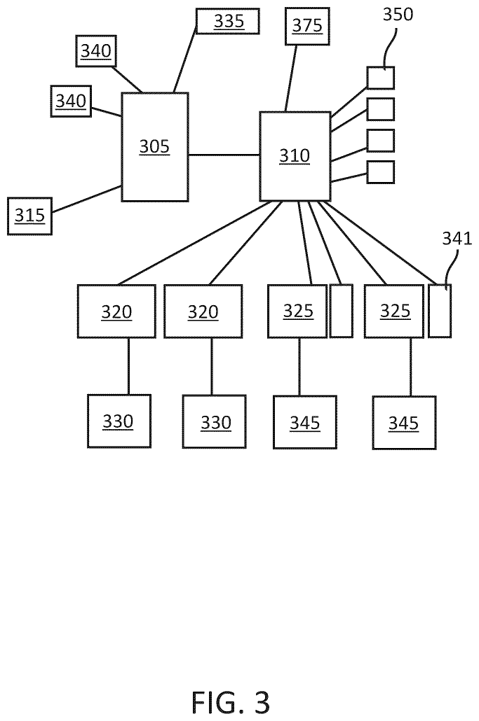

FIG. 3 illustrates a configuration for a controller, such as, for example, the controller 255 or 256 that can manage the operation of a system capable of cleaning fluid conduits, such as, for example, the system of FIGS. 2A and/or 2B. The controller can include a compute device 305, a microcontroller 310, a power distribution unit 315, and drivers 320 and 325. Drivers 320 and 325 can be software on microcontroller 310. Compute device 305 can be, for example, a small device, such as, for example, a processor, a next unit of computing (NUC) device, an edge computing device, a desktop, laptop, or resources that are allocated from a larger compute device, such as a server. Compute device 305 can include memory for storing software applications. Compute device 305 can be communicatively coupled to a microcontroller 310. Drivers 320 can be solenoid drivers and drivers 325 can be stepper motor drivers. Drivers 320 that are solenoid drivers can control solenoid valves 330 that control the fluid flow (e.g., on/off and flow rate) for the conduit mechanical cleaning device 220 during the operation of the device while cleaning a conduit. Drivers 325 that are stepper motor drivers can direct the operation of motors 345 that are stepper motors. Quadrature encoders 341 can also be connected to microcontroller 310 and can provide data that allows the determination of the location of the conduit mechanical cleaning device 220 relative to a chiller faceplate, for example. Microcontroller 310 is optionally connected to limit switches 350. Limit switches 350 can be, for example, the four translation limiters 245 of FIG. 1A. Compute device 305 can also be communicatively coupled to a camera 335, such as the camera 215, such as the cameras 215 of FIGS. 1A-1B, and optional time of flight (ToF) sensors 340, such as time of flight sensors 250 of FIG. 1A. Solenoid drivers 320 can be operably coupled to solenoid valves 330. Solenoid valves 330 can operate a fluid delivery system that provides fluid to a conduit mechanical cleaning device 220. Additionally, an optical sensor 375 (such as the optical sensor 225) can be communicatively coupled to microcontroller 310. The optical sensor 375 can provide data that allows the determination of whether or not a conduit mechanical cleaning device 220 is out of a fluid conduit. The microcontroller 310 can provide commands to the motors 325 and maintains an internal recording of the location of the end effector of conduit mechanical cleaning device 220 and states of all sensors. In the alternative, microcontroller 310 can be communicatively coupled to a driver (not shown) for a robotic arm (e.g., FIG. 1B), which can include drivers for stepper motors. Other configurations and numbers of parts are also possible.

In FIG. 1A, two stepper motors 235 are operably coupled to threaded rods 240 that are mounted on bars or rails and that are oriented so that one stepper motor 235 and threaded rod combination 240 allows translation along one of two axes. The two axes can be oriented at 90 degrees relative to each other. The movement of a camera and cleaning device can be controlled by a microcontroller 310 (FIG. 3). A microcontroller 310 can also be operably coupled to four limit switches 350 that can prevent the head (comprising a camera and cleaning device) from going beyond ranges necessary for cleaning operations. The microcontroller 310 can also be operably coupled to a cleaning control unit 230.

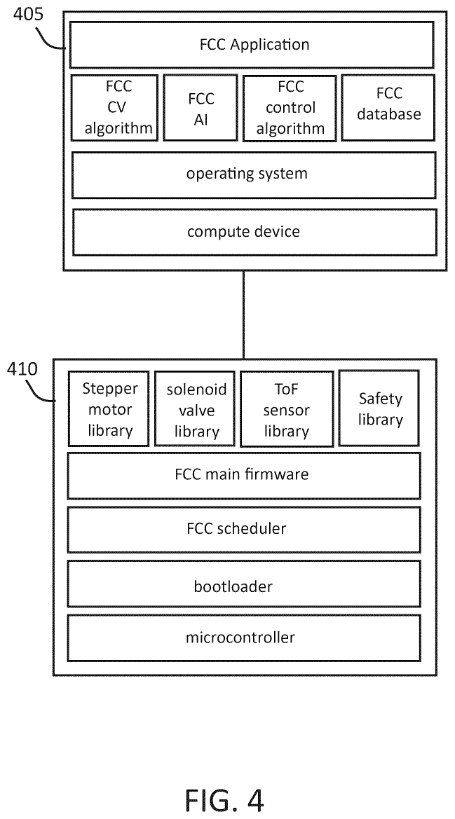

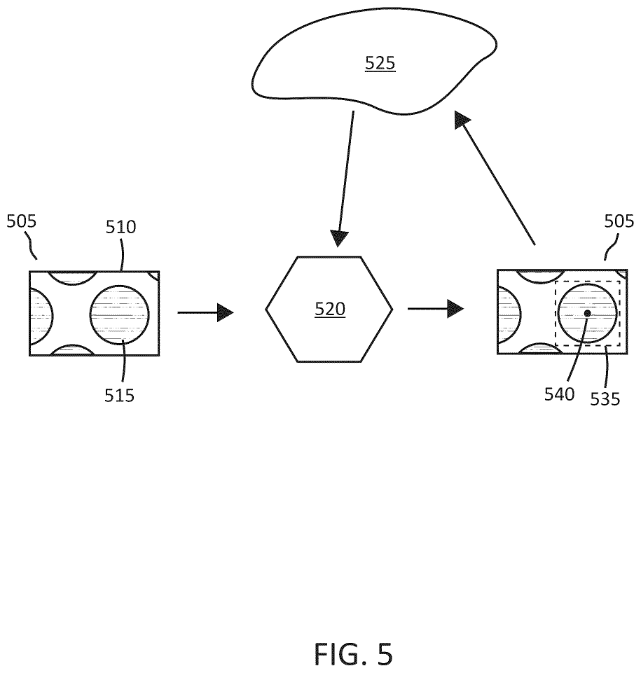

FIG. 4 provides a software stack that can be used as part of a system capable of cleaning fluid conduits. In FIG. 4, a fluid conduit cleaning (FCC) software stack associated with a computing device 405 is communicatively coupled with a FCC software stack associated with a microcontroller 410. The FCC software stack 405 includes the FCC application, a FCC computer vision (CV) algorithm, FCC AI (artificial intelligence), a FCC control algorithm, and a FCC database. The compute device FCC software can be run on, for example, a Linux operating system, although others are also possible, as the FCC software can be operating system (OS) independent. The FCC application can map a fluid conduit arrangement (such as the fluid conduits in a chiller FIGS. 2A-2B), using AI (artificial intelligence) and CV algorithms. The CV algorithm can use a convolutional neural network (CNN) algorithm for recognizing fluid tubes. The CNN can be trained to detect complete fluid tubes, partial tubes (if, from the location of the end effector, only a partial tube is seen by the camera), and plugs (if fluid conduits are plugged). In the alternative, a single-shot CV algorithm can use one image of the whole faceplate, detect all the fluid conduits, and compute a map of X and Y coordinates of fluid conduit centers. A map that is created of a fluid conduit arrangement can comprise the X,Y coordinates of each fluid conduit's center. The FCC database can store images of fluid conduits, X,Y coordinates of the fluid conduits, the state of the software and hardware (e.g., if the system stops operation, it can return to where it left off operating using state of the software and hardware information), and AI model metadata (e.g., model accuracy, confidence level, image quality, latency, and number of detections, among other possible data). The FCC AI algorithm can be, for example, one described herein and by FIG. 5.

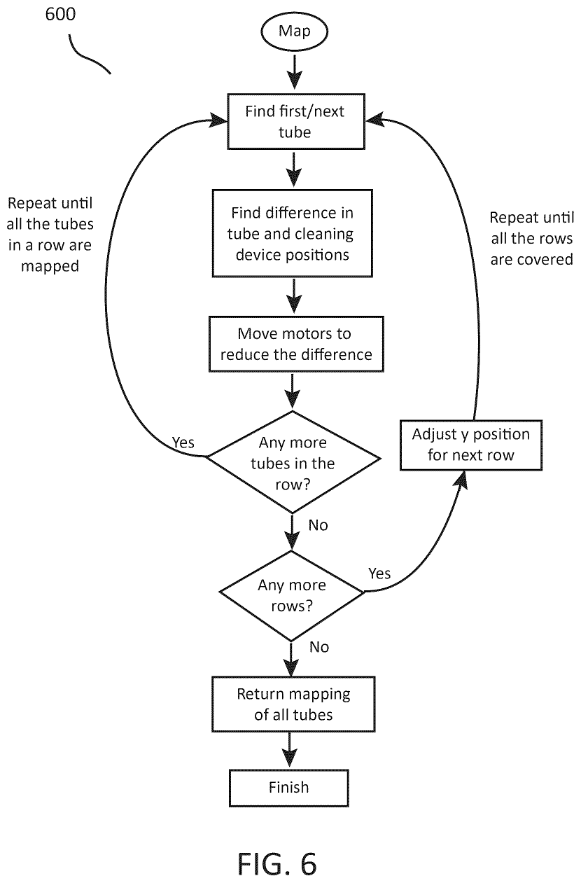

The FCC software stack 410 comprises a stepper motor library, a solenoid valve library, a time of flight (ToF) sensor library, a safety library, FCC main firmware, and FCC scheduler (collectively, FCC firmware). The FCC firmware can use a bootloader to run on a microcontroller. The FCC firmware can be ported to different microcontrollers using a pin mapping for the bootloader. A cleaning process can use the map to visit each fluid conduit for cleaning, such as sending a cleaning tool inside the fluid conduit for a period of time. A trigger mechanism to operate a cleaning tool can be controlled by the FCC software-firmware through the solenoid valves. During a mapping process, the camera can record pictures of fluid conduits that include the inner wall of the fluid conduit up to a certain depth (for example between 1 and 5 inches). The FCC scheduler can determine which tasks should be performed next. The FCC firmware can include all or part of the instructions to perform the operations described by FIGS. 6 and/or 7. The software stack 410 can also include an optical sensor library (not shown).

FIG. 5 illustrates a machine learning operations architecture that is useful for creating a map of fluid conduits having openings in a plane. A photo 505, such as, for example, one captured by camera 215 of the systems of FIGS. 2A-2B, shows a surface of heat exchanger housing face plate 510 that includes fluid tubes 515. An AI model 520 detects location data 535 (indicated by a square comprising dashed lines) of the fluid tubes 515. Data can be stored as X,Y coordinates for the center point 540 of the fluid tubes 515. AI model metadata can be sent to a machine learning algorithm 525 on, for example, a cloud-based server. AI model metadata includes, accuracy, confidence, image quality, latency, and detections. The AI model can be the FCC AI algorithm of FIG. 4.

FIG. 6 diagrams a mapping algorithm 600 that is useful for creating a map of fluid conduits for use in a system capable of cleaning fluid conduits, such as, for example, those described herein and in FIGS. 2A-2B and 3-4. Mapping algorithm 600 finds the first (or next) fluid conduit, finds the difference in the fluid conduit position (based on an X,Y coordinate that is the center of the fluid conduit footprint (e.g., center point 540 in FIG. 5), and motors are moved to reduce the difference. If there are more fluid conduits in the row, the algorithm repeats finding the first (or next) fluid conduit, finding the difference in the fluid conduit position (based on an X,Y coordinate that is the center of the fluid conduit footprint (e.g., center point 540 in FIG. 5), and moving motors to reduce the difference. If there are no more fluid conduits in the row, the algorithm determines whether there are additional rows of fluid conduits. If there are no more rows of fluid conduits, then a mapping the fluid conduits is returned. If there are additional rows of fluid conduits, the motors adjust for the next row, and the algorithm moves to finding the first or next fluid conduit.

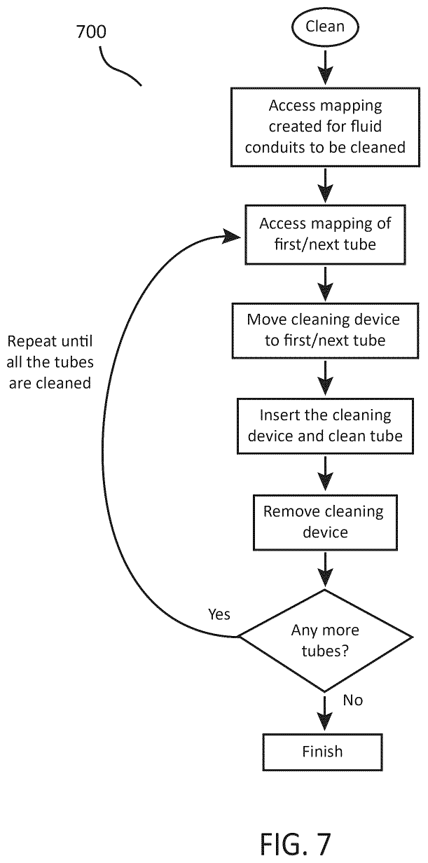

FIG. 7 diagrams an algorithm 700 useful for causing a system capable of cleaning fluid conduits to clean the fluid conduits of, for example, an enclosed heat exchanger 115. A system capable of cleaning fluid conduits, can be, for example, those described herein and in FIGS. 2A-2B and 3-4. A stored map is accessed and the X and Y coordinates of fluid conduit centers are read from the map. A cleaning device is pointed at an X, Y coordinate from the map through, for example moving motors 235 (or others). A cleaning control unit (e.g., cleaning control unit 230) is triggered and the cleaning device (e.g., conduit mechanical cleaning device 220) is sent into the fluid conduit. When the cleaning device reaches the end of the fluid conduit, the cleaning control unit is messaged and removes the cleaning device from the fluid conduit. A camera (e.g., camera 215) or other optical sensor is used to detect whether the cleaning device is entirely out of the fluid conduit. Limit switches are detected in order to keep the cleaning device in the desired range of, for example, a heat exchanger housing face plate 205. Operations can be repeated to clean some or all the fluid conduits.

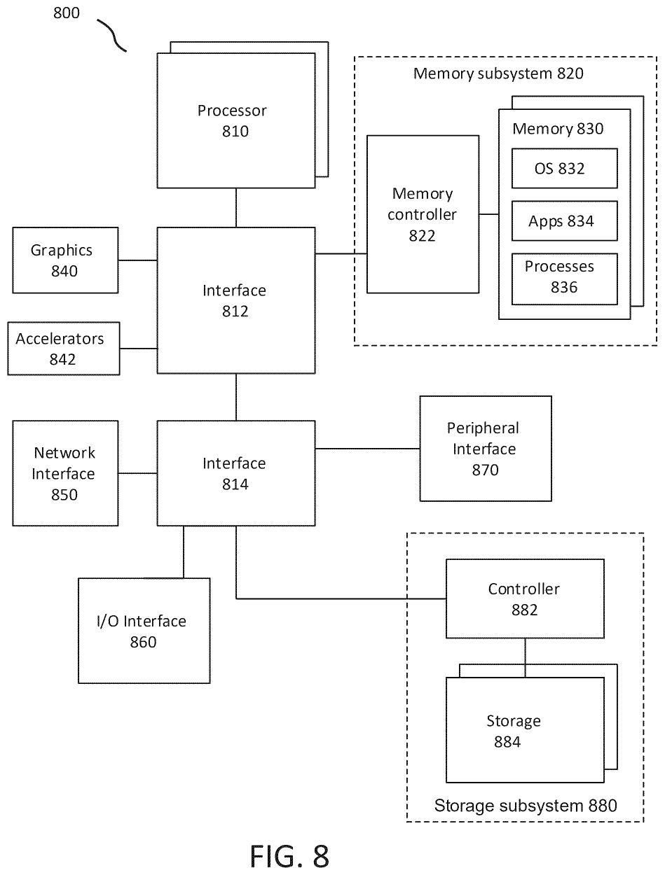

FIG. 8 depicts an example computing system which can be used in conjunction with systems capable of cleaning fluid conduits, such as those of FIGS. 2A and 2B. For example, the computing system can be the compute device of FIG. 4. Additionally, instructions for performing one or more aspects of the process described in FIGS. 6 and 7 can be stored and/or run on the computing system. A computing system 800 can include more, different, or fewer features than the ones described with respect to FIG. 8.

Computing system 800 includes processor 810, which provides processing, operation management, and execution of instructions for system 800. Processor 810 can include any type of microprocessor, CPU (central processing unit), GPU (graphics processing unit), processing core, or other processing hardware to provide processing for system 800, or a combination of processors or processing cores. Processor 810 controls the overall operation of system 800, and can be or include, one or more programmable general-purpose or special-purpose microprocessors, DSPs, programmable controllers, ASICs, programmable logic devices (PLDs), or the like, or a combination of such devices.

In one example, system 800 includes interface 812 coupled to processor 810, which can represent a higher speed interface or a high throughput interface for system components needing higher bandwidth connections, such as memory subsystem 820 or graphics interface components 840, and/or accelerators 842. Interface 812 represents an interface circuit, which can be a standalone component or integrated onto a processor die. Where present, graphics interface 840 interfaces to graphics components for providing a visual display to a user of system 800. In one example, the display can include a touchscreen display.

Accelerators 842 can be a fixed function or programmable offload engine that can be accessed or used by a processor 810. For example, an accelerator among accelerators 842 can provide data compression (DC) capability, cryptography services such as public key encryption (PKE), cipher, hash/authentication capabilities, decryption, or other capabilities or services. In some cases, accelerators 842 can be integrated into a CPU socket (e.g., a connector to a motherboard (or circuit board, printed circuit board, mainboard, system board, or logic board) that includes a CPU and provides an electrical interface with the CPU). For example, accelerators 842 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 842 can provide multiple neural networks, CPUs, processor cores, general purpose graphics processing units, or graphics processing units can be made available for use by artificial intelligence (AI) or machine learning (ML) models.

Memory subsystem 820 represents the main memory of system 800 and provides storage for code to be executed by processor 810, or data values to be used in executing a routine. Memory subsystem 820 can include one or more memory devices 830 such as read-only memory (ROM), flash memory, one or more varieties of random access memory (RAM) such as static RAM (SRAM), dynamic RAM (DRAM), synchronous DRAM (SDRAM) and/or or other memory devices, or a combination of such devices. Memory 830 stores and hosts, among other things, operating system (OS) 832 that provides a software platform for execution of instructions in system 800, and stores and hosts applications 834 and processes 836. In one example, memory subsystem 820 includes memory controller 822, which is a memory controller to generate and issue commands to memory 830. The memory controller 822 can be a physical part of processor 810 or a physical part of interface 812. For example, memory controller 822 can be an integrated memory controller, integrated onto a circuit within processor 810.

System 800 can also optionally include one or more buses or bus systems between devices, such memory buses, graphics buses, and/or interface buses. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a peripheral component interface (PCI) or PCI express (PCIe) bus, a Hyper Transport or industry standard architecture (ISA) bus, a small computer system interface (SCSI) bus, a universal serial bus (USB), or a Firewire bus.

In one example, system 800 includes interface 814, which can be coupled to interface 812. In one example, interface 814 represents an interface circuit, which can include standalone components and integrated circuitry. In one example, user interface components or peripheral components, or both, couple to interface 814. Network interface 850 provides system 800 the ability to communicate with remote devices (e.g., servers or other computing devices) over one or more networks. Network interface 850 can include an Ethernet adapter, wireless interconnection components, cellular network interconnection components, USB, or other wired or wireless standards-based or proprietary interfaces. Network interface 850 can transmit data to a device that is in the same data center or rack or a remote device, which can include sending data stored in memory.

Some examples of network interface 850 are part of an infrastructure processing unit (IPU) or data processing unit (DPU), or used by an IPU or DPU. An xPU can refer at least to an IPU, DPU, GPU, GPGPU (general purpose computing on graphics processing units), or other processing units (e.g., accelerator devices). An IPU or DPU can include a network interface with one or more programmable pipelines or fixed function processors to perform offload of operations that can have been performed by a CPU. The IPU or DPU can include one or more memory devices.

In one example, system 800 includes one or more input/output (I/O) interface(s) 860. I/O interface 860 can include one or more interface components through which a user interacts with system 800 (e.g., audio, alphanumeric, tactile/touch, or other interfacing). Peripheral interface 870 can include additional types of hardware interfaces, such as, for example, interfaces to semiconductor fabrication equipment and/or electrostatic charge management devices.

In one example, system 800 includes storage subsystem 880. Storage subsystem 880 includes storage device(s) 884, which can be or include any conventional medium for storing data in a nonvolatile manner, such as one or more magnetic, solid state, and/or optical based disks. Storage 884 can be generically considered to be a “memory,” although memory 830 is typically the executing or operating memory to provide instructions to processor 810. Whereas storage 884 is nonvolatile, memory 830 can include volatile memory (e.g., the value or state of the data is indeterminate if power is interrupted to system 800). In one example, storage subsystem 880 includes controller 882 to interface with storage 884. In one example controller 882 is a physical part of interface 812 or processor 810 or can include circuits or logic in both processor 810 and interface 814.

A power source (not depicted) provides power to the components of system 800. More specifically, power source typically interfaces to one or multiple power supplies in system 800 to provide power to the components of system 800.

Examples of systems may be implemented in various types of computing, smart phones, tablets, personal computers, and networking equipment, such as switches, routers, racks, and blade servers such as those employed in a data center and/or server farm environment.

### EXAMPLES

A system can comprise: a microcontroller wherein the microcontroller includes a solenoid valve driver and a motor driver; a solenoid valve wherein the solenoid valve is operably coupled to the microcontroller; a motor wherein the motor is operably coupled to the microcontroller; a camera wherein the motor is capable of causing the camera to change location; a cleaning device that is capable of removing mineral deposits from a fluid conduit and is capable of extending into a length of the fluid conduit wherein the motor is capable of causing the cleaning device to change location and wherein the solenoid valve controls a flow of fluid to the cleaning device; and an optical sensor wherein the optical sensor is capable of returning data that can be used to determine X and Y coordinate of a center point of the fluid conduit. The microcontroller can be operably coupled to quadrature encoders that are capable of providing data related to the position of the cleaning device. The system can also include a compute device wherein the compute device includes a database that is capable of storing X and Y coordinates of a center point of a fluid conduit. The system of claim 1 also including a compute device wherein the compute device includes application that is capable of mapping a fluid conduit arrangement that includes X and Y coordinates of a fluid conduit. The system of claim 1 also including a compute device wherein the compute device includes a machine learning algorithm that can determine the X and Y coordinates of a fluid conduit from an image that contains the fluid conduit wherein the image is from the camera. The microcontroller can be operably coupled to time of flight sensors. The system can also include an optical sensor that is co-located with the cleaning device.

A method can comprise: accessing a map comprising X and Y coordinates of centers of fluid conduits to be cleaned; moving a cleaning device to a center of a fluid conduit to be cleaned based on an X and Y coordinate from the map comprising X and Y coordinates; causing the cleaning device to be inserted into the fluid conduit; causing the cleaning device to be removed from the fluid conduit; determining if an additional fluid conduit remains uncleaned; and accessing a map comprising X and Y coordinates of centers of fluid conduits to be cleaned a second time if an additional fluid conduit remains uncleaned. The method can also include using an optical sensor to determine whether the cleaning device is out of the fluid conduit. The method of claim 8 wherein moving the cleaning device includes directing movement of a robotic arm. Moving the cleaning device can include directing operation of stepper motors. The method can also include directing operation of solenoid valves to control flow of a fluid to the cleaning device. The method can also include storing information related to a state of a system that is performing the method. Moving a cleaning device to a center of a fluid conduit to be cleaned can include using data from an optical sensor to determine a location of a center of a fluid conduit.

At least one machine-readable storage medium can comprise non-transitory instructions, that when executed by a processor, cause a device to: access a map comprising X and Y coordinates of centers of fluid conduits to be cleaned; move a cleaning device to a center of a fluid conduit to be cleaned based on an X and Y coordinate from the map comprising X and Y coordinates; cause the cleaning device to be inserted into the fluid conduit; cause the cleaning device to be removed from the fluid conduit; determine if an additional fluid conduit remains uncleaned; and access a map comprising X and Y coordinates of centers of fluid conduits to be cleaned a second time if an additional fluid conduit remains uncleaned. The at least one machine-readable storage medium can also include non-transitory instructions to use an optical sensor to determine whether the cleaning device is out of the fluid conduit to be cleaned. The at least one machine-readable storage medium can also include direct movement of a robotic arm. The at least one machine-readable storage medium can also include direct operation of solenoid valves that control flow of a fluid to the cleaning device. The at least one machine-readable storage medium can also include store information related to a state of a system that is executing the instructions. The at least one machine-readable storage medium wherein move a cleaning device to a center of a fluid conduit to be cleaned can include using data from an optical sensor to determine a location of a center of a fluid conduit.

Besides what is described herein, various modifications can be made to what is disclosed and implementations without departing from their scope. Therefore, the illustrations and examples herein should be construed in an illustrative, and not a restrictive sense.

What is claimed is:

1. A system comprising:
a microcontroller wherein the microcontroller includes a solenoid valve driver and a motor driver;
a solenoid valve wherein the solenoid valve is operably coupled to the microcontroller;
a motor wherein the motor is operably coupled to the microcontroller;
a camera wherein the motor is capable of causing the camera to change location;
a cleaning device that is capable of removing mineral deposits from a fluid conduit and is capable of extending into a length of the fluid conduit wherein the motor is capable of causing the cleaning device to change location and wherein the solenoid valve controls a flow of fluid to the cleaning device; and
an optical sensor wherein the optical sensor is capable of returning data that can be used to determine X and Y coordinate of a center point of the fluid conduit.

2. The system of claim 1, wherein the microcontroller is operably coupled to quadrature encoders that are capable of providing data related to the position of the cleaning device.

3. The system of claim 1 also including a compute device wherein the compute device includes a database that is capable of storing X and Y coordinates of a center point of a fluid conduit.

4. The system of claim 1 also including a compute device wherein the compute device includes an application that is capable of mapping a fluid conduit arrangement that includes X and Y coordinates of a center point of a fluid conduit.

5. The system of claim 1 also including a compute device wherein the compute device includes a machine learning algorithm that is capable of determining the X and Y coordinates of a center point of a fluid conduit from an image that contains the fluid conduit wherein the image is from the camera.

6. The system of claim 1 wherein the microcontroller is operably coupled to time of flight sensors.

7. The system of claim 1 also including an optical sensor that is co-located with the cleaning device.

8. A method comprising:
accessing a map comprising X and Y coordinates of centers of fluid conduits to be cleaned;
moving a cleaning device to a center of a fluid conduit to be cleaned based on an X and Y coordinate from the map comprising X and Y coordinates;
causing the cleaning device to be inserted into the fluid conduit;
causing the cleaning device to be removed from the fluid conduit;
determining if an additional fluid conduit remains uncleaned; and
accessing a map comprising X and Y coordinates of centers of fluid conduits to be cleaned a second time if an additional fluid conduit remains uncleaned.

9. The method of claim 8 also including using an optical sensor to determine whether the cleaning device is out of the fluid conduit.

10. The method of claim 8 wherein moving the cleaning device includes directing movement of a robotic arm.

11. The method of claim 8 wherein moving the cleaning device includes directing operation of stepper motors.

12. The method of claim 8 also including directing operation of solenoid valves to control flow of a fluid to the cleaning device.

13. The method of claim 8 also including storing information related to a state of a system that is performing the method.

14. The method of claim 8 wherein moving a cleaning device to a center of a fluid conduit to be cleaned includes using data from an optical sensor to determine a location of a center of a fluid conduit.

15. At least one machine-readable storage medium comprising non-transitory instructions, that when executed by a processor, cause a device to:
access a map comprising X and Y coordinates of centers of fluid conduits to be cleaned;
move a cleaning device to a center of a fluid conduit to be cleaned based on an X and Y coordinate from the map comprising X and Y coordinates;
cause the cleaning device to be inserted into the fluid conduit;
cause the cleaning device to be removed from the fluid conduit; and
determine if an additional fluid conduit remains uncleaned; and
access a map comprising X and Y coordinates of centers of fluid conduits to be cleaned a second time if an additional fluid conduit remains uncleaned.

16. The at least one machine-readable storage medium of claim 15 also including use an optical sensor to determine whether the cleaning device is out of the fluid conduit to be cleaned.

17. The at least one machine-readable storage medium of claim 15 also including direct movement of a robotic arm.

18. The at least one machine-readable storage medium of claim 15 also including direct operation of solenoid valves that control flow of a fluid to the cleaning device.

19. The at least one machine-readable storage medium of claim 15 also including store information related to a state of a system that is executing the instructions.

20. The at least one machine-readable storage medium of claim 15 wherein move a cleaning device to a center of a fluid conduit to be cleaned includes using data from an optical sensor to determine a location of a center of a fluid conduit.
